(19) United States
(12) Patent Application Publication
(10) Pub. No.: US 2023/0134720 A1
(43) Pub. Date: May 4, 2023

(54) AQUEOUS POLYURETHANE RESIN DISPERSION FOR SECONDARY BATTERY SEPARATOR, SECONDARY BATTERY SEPARATOR, AND SECONDARY BATTERY

(71) Applicant: DKS Co. Ltd., Kyoto-shi, Kyoto (JP)

(72) Inventors: Akiyoshi NISHIKAWA, Kyoto-shi, Kyoto (JP); Tetsuya HIGASHIZAKI, Kyoto-shi, Kyoto (JP); Ayano SOFUE, Kyoto-shi, Kyoto (JP); Toshiya WATANABE, Kyoto-shi, Kyoto (JP); Fumiya KANEKO, Kyoto-shi, Kyoto (JP)

(73) Assignee: DKS Co. Ltd., Kyoto-shi, Kyoto (JP)

(21) Appl. No.: 17/910,566

(22) PCT Filed: Mar. 9, 2021
(86) PCT No.: PCT/JP2021/009277

§ 371 Date: Sep. 9, 2022

(30) Foreign Application Priority Data
Mar. 17, 2020 (JP) 2020-046852

(51) Int. Cl. H01M 50/414; C08L 75/04; C08G 18/08; C08G 18/62; C08G 18/44; C08G 18/75; C08G 18/76

(52) U.S. Cl. CPC H01M 50/414; C08L 75/04; C08G 18/0866; C08G 18/6208; C08G 18/44; C08G 18/755; C08G 18/7671; C08L 2201/54

(57) ABSTRACT

A technology which exhibits a low internal resistance and good output characteristics is provided.

An aqueous polyurethane resin dispersion for a secondary battery separator includes an aqueous polyurethane resin dispersion containing a polyurethane resin dispersed in water, the polyurethane resin being obtained by reacting a polyol, a polyisocyanate compound, and a chain extender. The polyol contains a polycarbonate polyol. The polyurethane resin has a crosslink density of 0.02 mol/kg or more and 0.28 mol/kg or less.

### TECHNICAL FIELD

The present invention relates to an aqueous polyurethane resin dispersion for a secondary battery separator, a secondary battery separator, and a secondary battery.

### BACKGROUND ART

It has been known that secondary batteries are used as power sources for mobile terminals such as notebook personal computers, mobile phones, and personal digital assistants (PDA) (for example, PTL 1). There is also known a method in which an aqueous polyurethane resin dispersion is used for a separator for a secondary battery in order to improve the performance of the secondary battery (for example, PTL 1).

PTL 1 discloses, for the purpose of improving, for example, electrolyte solution resistance and adhesiveness, an aqueous polyurethane resin dispersion for a secondary battery separator, the aqueous polyurethane resin dispersion using a polyisocyanate and a polyolefin-based polyol except for a hydrogenated polybutadiene polyol having less than two hydroxyl groups in one molecule.

### CITATION LIST

### Patent Literature

PTL 1: Japanese Patent No. 5988344

### SUMMARY OF INVENTION

### Technical Problem

However, the aqueous polyurethane resin dispersion for a secondary battery separator described in PTL 1 has room for improvement in internal resistance and output characteristics. Therefore, an aqueous polyurethane resin dispersion for a secondary battery separator, the aqueous polyurethane resin dispersion being used for obtaining a secondary battery having a low internal resistance and good output characteristics, has been desired.

### Solution to Problem

The present invention has been made in order to solve the problems described above, and can be realized as the following aspects.

(1) According to an aspect of the present invention, there is provided an aqueous polyurethane resin dispersion for a secondary battery separator. This aqueous polyurethane resin dispersion for a secondary battery separator includes

an aqueous polyurethane resin dispersion containing a polyurethane resin dispersed in water, the polyurethane resin being obtained by reacting a polyol, a polyisocyanate compound, and a chain extender,

in which the polyol contains a polycarbonate polyol, and

the polyurethane resin has a crosslink density of 0.02 mol/kg or more and 0.28 mol/kg or less.

According to the aqueous polyurethane resin dispersion for a secondary battery separator of this aspect, a secondary battery having a low internal resistance and good output characteristics can be obtained.

(2) In the aqueous polyurethane resin dispersion for a secondary battery separator of the above aspect, the polyol may contain a polyhydric polyol.

According to the aqueous polyurethane resin dispersion for a secondary battery separator of this aspect, a secondary battery having a lower internal resistance and better output characteristics can be obtained.

(3) According to another aspect of the present invention, there is provided an aqueous polyurethane resin dispersion for a secondary battery separator. This aqueous polyurethane resin dispersion for a secondary battery separator includes

an aqueous polyurethane resin dispersion containing a polyurethane resin dispersed in water, the polyurethane resin being obtained by reacting a polyol, a polyisocyanate compound, and a chain extender,

in which the polyol contains a polycarbonate polyol and a polyolefin polyol.

According to the aqueous polyurethane resin dispersion for a secondary battery separator of this aspect, a secondary battery having a low internal resistance and good output characteristics can be obtained.

(4) In the aqueous polyurethane resin dispersion for a secondary battery separator of the above aspect, in the polyol, a content of the polycarbonate polyol may be 10 parts by mass or more and 95 parts by mass or less relative to 100 parts by mass of a total content of the polycarbonate polyol and the polyolefin polyol.

According to the aqueous polyurethane resin dispersion for a secondary battery separator of this aspect, a secondary battery having a lower internal resistance and better output characteristics can be obtained.

(5) According to another aspect of the present invention, there is provided a separator for a secondary battery, the separator being obtained using the above aqueous polyurethane resin dispersion for a secondary battery separator.
(6) According to another aspect of the present invention, there is provided a secondary battery including a positive electrode, a negative electrode, a separator, and an electrolyte solution, in which the separator is the separator for a secondary battery according to the above aspect.

### DESCRIPTION OF EMBODIMENTS

Hereafter, preferred embodiments of the present invention will be described.

### <Aqueous Polyurethane Resin Dispersion>

An aqueous polyurethane resin dispersion for a secondary battery separator according to an embodiment of the present invention includes an aqueous polyurethane resin dispersion containing a polyurethane resin dispersed in water, the polyurethane resin being obtained by reacting a polyol, a polyisocyanate compound, and a chain extender.

In the aqueous polyurethane resin dispersion for a secondary battery separator according to an embodiment of the present invention, the polyol contains a polycarbonate polyol, and the polyurethane resin has a crosslink density of 0.02 mol/kg or more and 0.28 mol/kg or less.

When the aqueous polyurethane resin dispersion for a secondary battery separator of this embodiment is used for a separator, a secondary battery having a low internal resistance and good output characteristics is obtained. Although the mechanism for this is not clear, the following mechanism is conceivable. That is, probably, a polycarbonate component derived from the polycarbonate polyol in the polyurethane resin swells in an electrolyte solution, and the electrical resistance of the polyurethane resin thereby decreases. In addition, probably, since the polyurethane resin has a crosslink density within the above range, a certain strength can be maintained even in the state where the polycarbonate component swells in the electrolyte solution, and thus output characteristics are good. From the viewpoint of obtaining a secondary battery having a low internal resistance and good output characteristics, the polyol preferably contains a polyhydric polyol. When the aqueous polyurethane resin dispersion for a secondary battery separator of this embodiment is used for a separator, a secondary battery having a good discharge average voltage is considered to be obtained.

The crosslink density of the polyurethane resin is more preferably 0.03 mol/kg or more, still more preferably 0.04 mol/kg or more. The crosslink density is preferably 0.25 mol/kg or less, more preferably 0.20 mol/kg or less.

Herein, the crosslink density can be calculated by the following method. That is, it is possible to determine, by calculation using a formula below, the crosslink density per 1,000 g of a resin solid component contained in an aqueous polyurethane dispersion obtained by reacting a mass W_{A1} g of a polyisocyanate (A) having a molecular weight MW_{A1} and a number F_{A1} of functional groups, a mass W_{A2} g of a polyisocyanate (A) having a molecular weight MW_{A2} and a number F_{A2} of functional groups, and a mass W_{Aj} g of a polyisocyanate (A) having a molecular weight MW_{Aj} and a number F_{Aj} of functional groups (where j is an integer of 1 or more); a mass W_{B1} g of an active hydrogen group-containing compound (B) having a molecular weight MW_{B1} and a number F_{B1} of functional groups, a mass W_{B2} g of an active hydrogen group-containing compound (B) having a molecular weight MW_{B2} and a number F_{B2} of functional groups, and a mass W_{Bk} g of an active hydrogen group-containing compound (B) having a molecular weight MW_{Bk} and a number F_{Bk} of functional groups (where k is an integer of 1 or more); a mass W_{C1} g of a compound (C) having one or more active hydrogen groups and a hydrophilic group and having a molecular weight MW_{C1} and a number F_{C1} of functional groups, and a mass W_{Cm} g of a compound (C) having one or more active hydrogen groups and a hydrophilic group and having a molecular weight MW_{Cm} and a number F_{Cm} of functional groups (where m is an integer of 1 or more); and a mass W_{D1} g of a chain extender (D) having a molecular weight MW_{D1} and a number F_{D1} of functional groups, and a mass W_{Dn} g of a chain extender (D) having a molecular weight MW_{Dn} and a number F_{Dn} of functional groups (where n is an integer of 1 or more). Note that the active hydrogen group is a functional group that reacts with an isocyanate group, and includes a hydroxyl group and an amino group.

$$Crosslink density = ( \frac{( {W}_{A 1} ( {F}_{A 1} - 2 ) / {MW}_{A 1} ) + ( {W}_{A 2} ( {F}_{A 2} - 2 ) / {MW}_{A 2} ) + … + ( {W}_{Aj} ( {F}_{Aj} - 2 ) / {MW}_{Aj} )}{( {W}_{A 1} + {W}_{A 2} + … + {W}_{Aj} ) + ( {W}_{B 1} + {W}_{B 2} + … + {W}_{Bk} ) + ( {W}_{C 1} + … + {W}_{C m} ) + ( {W}_{D 1} + … + {W}_{D o} )} + \frac{( {W}_{B 1} ( {F}_{B 1} - 2 ) / {MW}_{B 1} ) + ( {W}_{B 2} ( {F}_{B 2} - 2 ) / {MW}_{B 2} ) + … + ( {W}_{Bk} ( {F}_{Bk} - 2 ) / {MW}_{Bk} )}{( {W}_{A 1} + {W}_{A 2} + … + {W}_{Aj} ) + ( {W}_{B 1} + {W}_{B 2} + … + {W}_{Bk} ) + ( {W}_{C 1} + … + {W}_{C m} ) + ( {W}_{D 1} + … + {W}_{D o} )} + \frac{( {W}_{C 1} ( {F}_{C 1} - 2 ) / {MW}_{C 1} ) + … + ( {W}_{Cm} ( {F}_{Cm} - 2 ) / {MW}_{Cm} )}{( {W}_{A 1} + {W}_{A 2} + … + {W}_{Aj} ) + ( {W}_{B 1} + {W}_{B 2} + … + {W}_{Bk} ) + ( {W}_{C 1} + … + {W}_{C m} ) + ( {W}_{D 1} + … + {W}_{D o} )} + \frac{( {W}_{D 1} ( {F}_{D 1} - 2 ) / {MW}_{D 1} ) + … + ( {W}_{Do} ( {F}_{Do} - 2 ) / {MW}_{Do} )}{( {W}_{A 1} + {W}_{A 2} + … + {W}_{Aj} ) + ( {W}_{B 1} + {W}_{B 2} + … + {W}_{Bk} ) + ( {W}_{C 1} + … + {W}_{C m} ) + ( {W}_{D 1} + … + {W}_{D o} )} ) ⨯ 1000$$

In the aqueous polyurethane resin dispersion for a secondary battery separator according to another embodiment of the present invention, the polyol contains a polycarbonate polyol and a polyolefin polyol.

When the aqueous polyurethane resin dispersion for a secondary battery separator of this embodiment is used for a separator, a secondary battery having a low internal resistance and good output characteristics is obtained. Although the mechanism for this is not clear, the following mechanism is conceivable. Probably, a polycarbonate component derived from the polycarbonate polyol in the polyurethane resin swells in an electrolyte solution, and the electrical resistance of the polyurethane resin thereby decreases. In addition, probably, since the polyurethane resin contains a polyolefin component that is derived from the polyolefin polyol and that does not swell in the electrolyte solution, a certain strength can be maintained even in the state of swelling in the electrolyte solution, and thus output characteristics are good.

### <Polyol>

The term “polyol” as used herein refers to a compound having two or more hydroxyl groups in a molecule. Examples of polyols include, but are not particularly limited to, polycarbonate polyols and polyolefin polyols. When a polycarbonate polyol and a polyolefin polyol are used in combination, a content of the polycarbonate polyol is preferably 10 parts by mass or more and 95 parts by mass or less relative to 100 parts by mass of a total content of the polycarbonate polyol and the polyolefin polyol. In such a case, the polyurethane resin swells moderately in an electrolyte solution, and a secondary battery that includes a separator containing the polyurethane resin has a low internal resistance and has good output characteristics and a good discharge average voltage. The content of the polycarbonate polyol is more preferably 20 parts by mass or more and 90 parts by mass or less, still more preferably 30 parts by mass or more and 75 parts by mass or less relative to 100 parts by mass of the total content of the polycarbonate polyol and the polyolefin polyol.

Examples of polyols other than polycarbonate polyols and polyolefin polyols include, but are not particularly limited to, polyhydric alcohols, polyether polyols, polyester polyols, polyether-ester polyols, polyacrylic polyols, polyacetal polyols, polysiloxane polyols, and fluoropolyols.

Examples of polyhydric alcohols include, but are not particularly limited to, ethylene glycol, diethylene glycol, butanediol, propylene glycol, hexanediol, bisphenol A, bisphenol B, bisphenol S, hydrogenated bisphenol A, dibromobisphenol A, 1,4-cyclohexanedimethanol, dihydroxyethyl terephthalate, hydroquinone dihydroxyethyl ether, trimethylolpropane, glycerin, and pentaerythritol.

Examples of polyether polyols include, but are not particularly limited to, alkylene derivatives of polyhydric alcohols, polytetramethylene glycol, and polythioether polyols. Examples of polyester polyols and polyether-ester polyols include, but are not particularly limited to, esterified products obtained from polyhydric alcohols, polycarboxylic acids, polycarboxylic acid anhydrides, polyether polyols, and polycarboxylic acid esters; castor oil polyol; and polycaprolactone polyol. Of these, polyether polyols and polyester polyols are preferred. These may be used alone or in combination of two or more thereof. These may be used in combination with a compound having one hydroxyl group.

The polyol preferably contains a polyhydric polyol. The term “polyhydric polyol” as used herein refers to a polyol having three or more hydroxyl groups in one molecule. Examples of polyhydric polyols include, but are not particularly limited to, polyhydric alcohols such as trimethylolpropane, glycerin, and pentaerythritol; oxyalkylene derivatives thereof; and ester compounds obtained from any of the polyhydric alcohols and oxyalkylene derivatives and a polycarboxylic acid, a polycarboxylic acid anhydride, or a polycarboxylic acid ester.

Polycarbonate polyols are not particularly limited, and, for example, polycarbonate polyols that are typically used in this technical field can be used. Examples of polycarbonate polyols include carbonate polyol of 1,6-hexanediol, carbonate polyol of 1,4-butanediol and 1,6-hexanediol, carbonate polyol of 1,5-pentanediol and 1,6-hexanediol, carbonate polyol of 3-methyl-1,5-pentanediol and 1,6-hexanediol, carbonate polyol of 1,9-nonanediol and 2-methyl-1,8-octanediol, carbonate polyol of 1,4-cyclohexanedimethanol and 1,6-hexanediol, and carbonate polyol of 1,4-cyclohexanedimethanol. More specifically, examples thereof include PCDL T-6001, T-6002, T-5651, T-5652, T-5650J, T-4671, and T-4672 manufactured by Asahi Kasei Corporation; Kuraray Polyols C-590, C-1050, C-1050R, C-1090, C-2050, C-2050R, C-2070, C-2070R, C-2090, C-2090R, C-3090, C-3090R, C-4090, C-4090R, C-5090, C-5090R, C-1065N, C-2065N, C-1015N, and C-2015N manufactured by Kuraray Co., Ltd.; and ETERNACOLL UH-50, UH-100, UH-200, UH-300, UM-90 (3/1), UM-90 (1/1), UM-90 (1/3), and UC-100 manufactured by UBE Corporation.

The term “polyolefin polyol” as used herein refers to a polymer or copolymer of a diolefin having 4 to 12 carbon atoms, such as butadiene or isoprene, the polymer or copolymer being a compound containing hydroxyl groups. Examples of polyolefin polyols include, but are not particularly limited to, copolymers of a diolefin having 4 to 12 carbon atoms and an α-olefin having 2 to 22 carbon atoms. The method for introducing a hydroxyl group is not particularly limited, but may be, for example, a method for reacting a diene monomer with hydrogen peroxide. Furthermore, remaining double bonds may be subjected to hydrogenation to make a saturated aliphatic compound. Examples of such polyolefin polyols include “NISSO-PB G” Series manufactured by Nippon Soda Co., Ltd., “Poly bd” Series and “EPOL (registered trademark)” manufactured by Idemitsu Kosan Co., Ltd., and “Krasol (registered trademark)” Series manufactured by CRAY VALLEY.

### <Polyisocyanate Compound>

Examples of polyisocyanate compounds include, but are not particularly limited to, organic polyisocyanates. Examples of organic polyisocyanates include, but are not particularly limited to, aromatic, aliphatic, alicyclic, and araliphatic polyisocyanates. The polyisocyanate compounds are preferably organic polyisocyanates such as 4,4′-dicyclohexylmethane diisocyanate, isophorone diisocyanate, hydrogenated xylylene diisocyanate [bis(isocyanatomethyl)cyclohexane], hexamethylene diisocyanate, lysine diisocyanate, norbornane diisocyanate, and xylylene diisocyanate; and modified products thereof. The polyisocyanate compounds are more preferably 4,4′-dicyclohexylmethane diisocyanate and isophorone diisocyanate. The polyisocyanate compounds may be used alone or in combination of two or more thereof.

A ratio (isocyanate group/hydroxyl group) (molar equivalent ratio) of isocyanate groups to hydroxyl groups used to obtain a urethane prepolymer is not particularly limited but is preferably 1.05 or more. The ratio (isocyanate group/hydroxyl group) (molar equivalent ratio) of isocyanate groups to hydroxyl groups used to obtain a urethane prepolymer is more preferably 1.08 or more and 3.00 or less, still more preferably 1.10 or more and 2.20 or less from the viewpoint of obtaining a stable emulsified product while making the viscosity of the urethane prepolymer low.

An average molecular weight of the urethane prepolymer is preferably 15,000 or less, more preferably 10,000 or less in view of emulsifiability and emulsification stability. The term “average molecular weight” as used herein refers to a theoretical value calculated from number-average molecular weights of loaded raw materials.

The content of hydrophilic groups in the urethane prepolymer is not particularly limited but is, for example, 0.03 to 2.10 mmol/g, more preferably 0.06 to 1.80 mmol/g, still more preferably 0.09 to 1.60 mmol/g.

The hydrophilic groups are not particularly limited and may be anionic groups, cationic groups, or nonionic groups. Of these, anionic groups and cationic groups are preferred.

Examples of the hydrophilic group compound for introducing a hydrophilic group into a urethane prepolymer include, but are not particularly limited to, neutralized products of a (di)alkanol carboxylic acid or sulfonic acid with a tertiary amine or an alkali metal, (methoxy)polyalkylene oxides, organic/inorganic acid neutralized products of a (di)alkanolamine, and quaternary ammonium salts obtained by reacting an alkyl halide or a dialkylsulfuric acid with any of these. Of these, neutralized products of a (di)alkanol carboxylic acid or sulfonic acid with a tertiary amine or an alkali metal, organic/inorganic acid neutralized products of a (di)alkanolamine, and quaternary ammonium salts obtained by reacting an alkyl halide or a dialkylsulfuric acid with any of these are preferred. The (methoxy)polyalkylene oxides contain at least ethylene oxide as an alkylene oxide and may further contain alkylene oxides other than ethylene oxide, such as propylene oxide and butylene oxide. When a (methoxy)polyalkylene oxide containing a plurality of types of alkylene oxides is used, the addition form (introduction form of hydrophilic groups) may be either block addition or random addition.

Examples of hydrophilic group compounds for introducing a hydrophilic group into a urethane prepolymer include the following. Examples of hydrophilic group compounds for introducing an anionic group include salts obtained by neutralizing a carboxylic acid compound such as dimethylol propionic acid, dimethylol butanoic acid, lactic acid, or glycine, aminoethylsulfonic acid, or a sulfonic acid compound such as a polyester diol formed from sulfoisophthalic acid and a diol with triethylamine, NaOH, or a tertiary alkanolamine such as dimethylaminoethanol. Of these, sodium salts of dimethylol propionic acid, glycine, or aminoethylsulfonic acid are preferred.

Examples of hydrophilic group compounds for introducing a cationic group include salts obtained by neutralizing an alkanolamine such as dimethylaminoethanol or methyldiethanolamine with an organic carboxylic acid such as formic acid or acetic acid or an inorganic acid such as hydrochloric acid or sulfuric acid; and compounds obtained by quaternizing the above alkanolamine with an alkyl halide such as methyl chloride or methyl bromide or a dialkylsulfuric acid such as dimethylsulfuric acid. Of these, a combination of methyldiethanolamine and an organic carboxylic acid and a combination of methyldiethanolamine and dimethylsulfuric acid are preferred because the industrial production is easily achieved.

In this embodiment, a chain extender may be used. Examples of the chain extender include, but are not particularly limited to, aliphatic polyamines such as ethylenediamine, trimethylenediamine, propylenediamine, diethylenetriamine, and triethylenetetramine; aromatic polyamines such as meta-xylenediamine, tolylenediamine, and diaminodiphenylmethane; alicyclic polyamines such as piperazine and isophoronediamine; and polyhydrazides such as hydrazine and adipic dihydrazide. Of these, ethylenediamine and diethylenetriamine are preferred. The chain extension may be performed not only with the chain extender but also with water molecules that are present in the system during dispersion emulsification.

The content of the chain extender is not particularly limited but is preferably 0.1% by mass or more and 20% by mass or less, more preferably 0.2% by mass or more and 10% by mass or less based on the polyurethane resin. When the content is 0.1% by mass or more, a coating film that exhibits good electrolyte solution resistance is obtained. When the content is 20% by mass or less, the reduction in the internal resistance of the battery is particularly good.

The solid content of the polyurethane resin in the aqueous polyurethane resin dispersion is not particularly limited but, in view of workability, is preferably 1% by mass or more and 60% by mass or less, more preferably 3% by mass or more and 55% by mass or less, still more preferably 4% by mass or more and 50% by mass or less based on the aqueous dispersion.

Furthermore, various additives that are typically used can be used as necessary in the aqueous dispersion. Examples of such additives include, but are not particularly limited to, weather-resistant agents, antibacterial agents, fungicides, pigments, fillers, rust inhibitors, dyes, film formation assistants, inorganic crosslinking agents, organic crosslinking agents, silane coupling agents, antiblocking agents, viscosity modifiers, leveling agents, antifoaming agents, dispersion stabilizers, light stabilizers, antioxidants, ultraviolet absorbents, inorganic fillers, organic fillers, plasticizers, lubricants, and antistatic agents. Examples of organic crosslinking agents include, but are not particularly limited to, blocked isocyanate crosslinking agents, epoxy crosslinking agents, carbodiimide crosslinking agents, oxazoline crosslinking agents, and melamine crosslinking agents.

### <Separator Substrate>

A substrate of a separator for a secondary battery, the separator being obtained using the aqueous polyurethane resin dispersion of this embodiment, is not particularly limited but may be a separator that is typically used in a secondary battery. The substrate is preferably a porous membrane having electrical insulating properties, ionic conductivity, and high organic solvent resistance. Examples of the substrate include, but are not particularly limited to, microporous membranes containing, as a main component, a resin such as polyethylene, polypropylene, polyethylene terephthalate, polyamide, polyimide, polyamide-imide, or polyaramid; nonwoven fabrics of polyolefins or cellulose fibers; and paper. Of these, polyolefin is preferred because polyolefin has good coatability and thus the thickness of a coating layer can be reduced.

When the aqueous polyurethane resin dispersion of this embodiment is applied to a polyolefin-based microporous membrane, the microporous membrane is preferably subjected to surface treatment. This facilitates the application of the aqueous polyurethane resin dispersion and improves the adhesion strength. The surface treatment method is not particularly limited but is preferably a method by which microporous portions are not significantly broken. Examples of the surface treatment method include corona discharge treatment, plasma discharge treatment, mechanical surface roughening treatment, solvent treatment, acid treatment, and ultraviolet oxidation treatment.

### <Inorganic Ceramic>

The separator for a secondary battery according to this embodiment includes a layer containing inorganic ceramic. Examples of the inorganic ceramic in this embodiment include, but are not particularly limited to, alumina, boehmite, silicon dioxide, zirconium oxide, and titanium oxide. Of these, alumna is preferred in view of the cost and availability.

### <Secondary Battery>

A secondary battery of this embodiment includes a positive electrode, a negative electrode, a separator, and an electrolyte solution. The separator is obtained using the aqueous polyurethane resin dispersion described above. In this embodiment, a lithium-ion secondary battery using a nonaqueous electrolyte solution is used, but the secondary battery is not limited thereto. Examples of other secondary batteries include electric double-layer capacitors, lithium-ion capacitors, and sodium-ion secondary batteries.

### <Method for Producing Aqueous Polyurethane Resin Dispersion>

The method for producing an aqueous polyurethane resin dispersion is not particularly limited, and a publicly known method can be employed. The method for producing an aqueous polyurethane resin dispersion may be, for example, the following method. First, a polyol, an isocyanate compound, and, if necessary, a hydrophilic group-containing compound are reacted under reaction conditions of 30° C. to 130° C. for about 0.5 hours to 10 hours, and the resulting reaction mixture is then cooled to 5° C. to 45° C. as required. Thus, hydrophilic groups are neutralized or quaternization is performed by adding a quaternizing agent in advance to obtain a urethane prepolymer. Any organic solvent such as acetone, methyl ethyl ketone, tetrahydrofuran, dioxane, ethyl acetate, or butyl acetate can be used as a solvent. The urethane prepolymer is further emulsified and subjected to chain extension to produce an aqueous polyurethane resin dispersion. As water used for emulsification, 100 to 900 parts by mass of water is preferably added relative to 100 parts by mass of the urethane prepolymer.

### <Method for Producing Secondary Battery Separator>

The method for producing a secondary battery separator is not particularly limited, and a publicly known method can be employed. The method for producing a secondary battery separator may be, for example, the following method. First, inorganic ceramic, carboxymethyl cellulose sodium salt, and an aqueous polyurethane resin dispersion are mixed to prepare slurry with high fluidity. Subsequently, this slurry is applied to a substrate to form a thin film and then dried. As a result, a coated separator with a thickness of 3 μm to 10 μm can be obtained.

### <Method for Producing Secondary Battery>

The method for producing a secondary battery is not particularly limited, and a publicly known method can be employed. The method for producing a secondary battery may be, for example, the following method. First, a positive electrode and a negative electrode are prepared. Subsequently, a separator is interposed between the positive electrode and the negative electrode to prepare a stack in which the positive electrode, the negative electrode, and the separator are stacked. Subsequently, this stack is placed in an aluminum laminate package, and the package is then sealed such that an opening for injecting an electrolyte solution is left to prepare a battery before electrolyte solution injection. Subsequently, an electrolyte solution is injected from the opening into this battery before electrolyte solution injection, and the opening is then sealed to obtain a lithium-ion secondary battery intermediate product. The lithium-ion secondary battery intermediate product is allowed to stand in an environment at room temperature for 24 hours and then subjected to a charging process to obtain a secondary battery.

Preferably, a film obtained from the aqueous polyurethane resin dispersion of this embodiment is not dissolved in the method described in Examples below. The electrolyte solution resistance of the film is preferably 20% or more and 2000% or less, more preferably 30% or more and 1000% or less. When the electrolyte solution resistance is controlled to the preferred lower limit or more, so that the phenomenon that the film component acts as a resistance component is suppressed, a degradation of output characteristics and a decrease in the discharge average voltage can be suppressed. On the other hand, when the electrolyte solution resistance is controlled to the preferred upper limit or less, so that a decrease in the binding force is suppressed, the phenomenon that the inorganic ceramic layer cannot be held can be suppressed. Here, by increasing the proportion of a polyol component having good compatibility with the electrolyte solution, swelling properties of the polyurethane film in the electrolyte solution can be enhanced. On the other hand, by increasing the proportion of a polyol component having poor compatibility with the electrolyte solution or by increasing the crosslink density, swelling properties of the film in the electrolyte solution can be degraded. In addition, by controlling the swelling properties, the electrolyte solution resistance can be controlled.

### EXAMPLES

Hereafter, the present invention will be described in more detail by way of Examples. It should be noted that the present invention is not limited to these Examples.

### <Raw Materials Used>

### (Polyolefin Polyol)

Polyolefin polyol (A1): Krasol LBH-P2000 (polybutadiene polyol, manufactured by CRAY VALLEY)

### (Polycarbonate Polyol)

Polycarbonate polyol (B1): DURANOL PCDL T5652 (1,5-pentanediol and 1,6-hexanediol-based polycarbonate polyol, manufactured by Asahi Kasei Corporation)

Polycarbonate polyol (B2): ETERNACOLL UH-200 (1,6-hexanediol-based polycarbonate polyol, manufactured by UBE Corporation)

### (Polyisocyanate Compound)

Polyisocyanate compound (C1): Isophorone diisocyanate

Polyisocyanate compound (C2): Hydrogenated diphenylmethane diisocyanate

### (Others)

Neutralization salt (Li): Lithium hydroxide monohydrate (manufactured by NACALAI TESQUE, INC.)

### <Production of Aqueous Polyurethane Resin Dispersion>

### Example 1

In a four-necked flask equipped with a stirrer, a reflux condenser, a thermometer, and a nitrogen inlet tube, 66.10 parts by mass of polyolefin polyol (A1), 10.00 parts by mass of polycarbonate polyol (B1), 4.80 parts by mass of dimethylol propionic acid (Bis-MPA), 18.40 parts by mass of polyisocyanate compound (C1), and 100 parts by mass of methyl ethyl ketone were placed. Subsequently, the resulting mixture was reacted at 75° C. for two hours to obtain a methyl ethyl ketone solution of a polyurethane prepolymer. This solution had a free isocyanate group content of 0.85% relative to nonvolatile matter.

Next, this solution was cooled to 45° C. and then neutralized by adding 3.60 parts by mass of triethylamine (TEA). Subsequently, emulsification reaction was conducted using a homogenizer while 186 parts by mass of water was gradually added to this solution. To the resulting emulsified dispersion, an aqueous solution in which 0.70 parts by mass of diethylenetriamine (DETA) was dissolved in 27.00 parts by mass of water was added, and the resulting mixture was then reacted for one hour. Subsequently, methyl ethyl ketone serving as the reaction solvent was distilled under reduced pressure to obtain an aqueous polyurethane resin dispersion having a nonvolatile matter (solid) content of 35% by mass.

### Examples 2 to 5 and Comparative Example 1

Aqueous polyurethane resin dispersions were synthesized by the same method as that in Example 1 except that the composition was changed to the corresponding composition shown in Table 1.

### Example 6

In a four-necked flask equipped with a stirrer, a reflux condenser, a thermometer, and a nitrogen inlet tube, 50.82 parts by mass of polycarbonate polyol (B1), 3.50 parts by mass of trimethylolpropane (TMP), 5.13 parts by mass of dimethylol propionic acid (Bis-MPA), 38.00 parts by mass of polyisocyanate compound (C2), and 100 parts by mass of methyl ethyl ketone were placed. Subsequently, the resulting mixture was reacted at 75° C. for two hours to obtain a methyl ethyl ketone solution of a polyurethane prepolymer. This solution had a free isocyanate group content of 3.68% relative to nonvolatile matter.

Next, this solution was cooled to 45° C. and then neutralized by adding 1.6 parts by mass of lithium hydroxide monohydrate dissolved in water (10% aqueous solution). Subsequently, emulsification reaction was conducted using a homogenizer while 186 parts by mass of water was gradually added to this solution. To the resulting emulsified dispersion, an aqueous solution in which 2.55 parts by mass of ethylenediamine (EDA) was dissolved in 27 parts by mass of water was added, and the resulting mixture was then reacted for one hour. Subsequently, methyl ethyl ketone serving as the reaction solvent was distilled under reduced pressure to obtain an aqueous polyurethane resin dispersion having a nonvolatile matter (solid) content of 35% by mass.

### Examples 7 to 12 and Comparative Example 2

Synthesis was performed as in the method described in Example 6 except that the composition was changed to the corresponding composition shown in Table 2.

### <Evaluation Method>

A film used in the evaluations below was prepared using the above aqueous polyurethane resin dispersion under the following conditions.

Conditions for film preparation: 40° C.×15 hours+80° C.×6 hours+120° C.×20 minutes

Dry film thickness=about 300 μm

An electrolyte solution used in the evaluations below was the following.

Electrolyte solution: Ethylene carbonate/Ethyl methyl carbonate=1/1 (volume ratio) mixed solution

### (Electrolyte Solution Resistance)

About 0.2 g of the film prepared as described above was cut to prepare a specimen. The mass of the specimen before immersion was measured, and the specimen was then immersed in the electrolyte solution at 70° C. for three days. Subsequently, the temperature was returned to room temperature, and the electrolyte solution on the surface was then wiped off. Subsequently, the mass of the specimen after immersion was measured. A rate of increase in mass (%) was calculated on the basis of the following formula.

Rate of increase in mass (%)=(mass after immersion−mass before immersion)/mass before immersion

### <Method for Preparing Battery Used for Experiment>

### (Preparation of Positive Electrode)

In a planetary mixer, 94.5 g of LiNi₅Co₂Mn₃ serving as a positive electrode active material, 2 g of SuperP (registered trademark) (manufactured by Imerys G C) and 2 g of TIMREX (registered trademark) KS6 (manufactured by Imerys G C) serving as conductive agents, 1.5 g of polyvinylidene fluoride (PVDF) (manufactured by Kureha Corporation) serving as a binder, and 47 g of N-methyl-2-pyrrolidone serving as a dispersion medium were mixed together to prepare a positive electrode coating material having a solid content of 68% by mass. The positive electrode coating material was applied to aluminum foil (thickness: 15 μm) serving as a current collector with a coating machine such that a coating mass per one surface became 19 mg/cm². Subsequently, the aluminum foil with the positive electrode coating material was dried at 130° C. under reduced pressure and then roll-pressed to obtain a positive electrode.

### (Preparation of Negative Electrode)

In a planetary mixer, 95.5 g of graphite serving as a negative electrode active material, 0.5 g of SuperP (registered trademark) (manufactured by Imerys G C) serving as a conductive agent, 2 g of CELLOGEN (registered trademark) BSH-6 (manufactured by DKS Co., Ltd.) serving as a thickener, 2 g of TRD-104A (manufactured by JSR Corporation) serving as a binder, and 100 g of pure water serving as a dispersion medium were mixed together to prepare a negative electrode coating material having a solid content of 49% by mass. The negative electrode coating material was applied to electrolytic copper foil (thickness: 10 μm) serving as a current collector with a coating machine such that a coating mass per one surface became 11 mg/cm². Subsequently, the electrolytic copper foil with the negative electrode coating material was dried at 130° C. under reduced pressure and then roll-pressed to obtain a negative electrode.

### (Preparation of Separator)

In a planetary mixer, 92 g of an alumina powder, 2 g of CELLOGEN (registered trademark) WS-C (manufactured by DKS Co., Ltd.), 6 g of an aqueous polyurethane resin dispersion based on the solid content, and a predetermined amount of pure water serving as a dispersion medium were mixed together to prepare alumina slurry having a solid content of 25% by mass. The alumina slurry was applied to a polyolefin separator (thickness: 25 μm) that had been subjected to corona treatment with a coating machine. Subsequently, drying was performed at 80° C. under reduced pressure to obtain a separator.

### (Preparation of Lithium-Ion Secondary Battery)

After the preparation of the positive electrode and the negative electrode, the separator was interposed between the positive electrode and the negative electrode to form a stack. A tab lead was ultrasonically welded on each of the positive electrode side and the negative electrode side to prepare a stack with tab leads. This stack with tab leads was placed in an aluminum laminate package, and the package was then sealed such that an opening for injecting an electrolyte solution was left to prepare a battery before electrolyte solution injection. Subsequently, an electrolyte solution (1 mol/L LiPF₆ EC/EMC=3 vol/7 vol) was injected from the opening into the battery before electrolyte solution injection, and the opening was then sealed to obtain a lithium-ion secondary battery intermediate product. The lithium-ion secondary battery intermediate product was allowed to stand in an environment at room temperature for 24 hours, and the battery was then fastened with a jig to obtain a lithium-ion secondary battery.

### (Evaluation of Battery Performance)

A 1 kHz alternating current resistance (ACR) was measured after constant current-constant voltage (CCCV) charging was performed at a current value of 0.2 C for 12 hours using a BATTERY HiTESTER 3561 (manufactured by HIOKI E.E. CORPORATION).

A discharge retention rate was a value determined by dividing, by the battery capacity, a capacity after CCCV charging was performed at a current value of 0.5 C for four hours and constant current (CC) discharging was subsequently performed at a current value of 1 C or 2 C (2.7 V stop). The discharge retention rate determined when CC discharging was performed at a current value of 1 C is referred to as a “1 C discharge retention rate”, and the discharge retention rate determined when CC discharging was performed at a current value of 2 C is referred to as a “2 C discharge retention rate”.

A direct current resistance (DCR) was calculated as follows. After CCCV charging was performed at a constant current of 0.5 C for one hour, a voltage after 1 C discharging for 10 seconds, a voltage after 2 C discharging for 10 seconds, and a voltage after 3 C discharging for 10 seconds were extracted, and a slope was determined from the relationship between the current value and the voltage. The DCR was calculated from the slope. In general, the lower the internal resistance of the DCR, the better the output characteristics.

The experimental results are shown below.

TABLE 1

| | | | | | | Comparative |
|---|---|---|---|---|---|---|
| | Example 1 | Example 2 | Example 3 | Example 4 | Example 5 | Example 1 |
| Polyolefin polyol (A1) | 66.1 | 37.7 | 37.7 | 36.1 | 37.7 | 65.02 |
| Polycarbonate polyol (B1) | 10 | 38.1 | | 36.8 | 38.1 | |
| Polycarbonate polyol (B2) | | | 38.1 | | | |
| Olefin ratio A1/(A1 + B1 + B2) | 0.87 | 0.50 | 0.50 | 0.50 | 0.50 | 1.00 |
| Carbonate ratio | 0.13 | 0.50 | 0.50 | 0.50 | 0.50 | 0.00 |
| (B1 + B2)/(A1 + B1 + B2) | | | | | | |
| TMP | | | | | | 0.3 |
| Bis-MPA | 4.8 | 4.8 | 4.8 | 4.8 | 4.8 | 5.13 |
| Polyisocyanate compound (C1) | 18.4 | 18.7 | 18.7 | | 18.7 | |
| Polyisocyanate compound (C2) | | | | 21.6 | | 27 |
| Amine extender (EDA) | | | | | | 2.55 |
| Amine extender (DETA) | 0.7 | 0.7 | 0.7 | 0.7 | 0.7 | |
| Neutralization salt (TEA) | 3.6 | 3.6 | 3.6 | 3.6 | | |
| Neutralization salt (Li) | | | | | 1.5 | 1.6 |
| Crosslink density [mol/kg] | 0.068 | 0.068 | 0.068 | 0.068 | 0.068 | 0.022 |
| Electrolyte solution resistance | 79 | 441 | 463 | 553 | 410 | 40 |
| 1 kHz ACR [Ω] | 0.9 | 0.47 | 0.48 | 0.55 | 0.52 | 1.15 |
| 1 C Discharge retention rate [%] | 91 | 93 | 92 | 92 | 93 | 85 |
| 2 C Discharge retention rate [%] | 82 | 84 | 83 | 83 | 82 | 9 |
| DCR [Ω] | 1.5 | 1.33 | 1.4 | 1.3 | 1.4 | 2.02 |

TABLE 2

| | Example | Example | Example | Example | Example | Example | Example | Comparative |
|---|---|---|---|---|---|---|---|---|
| | 6 | 7 | 8 | 9 | 10 | 11 | 12 | Example 2 |
| Polyolefin polyol (A1) | | | | | | | | |
| Polycarbonate polyol (B1) | 50.82 | 56.32 | 56.32 | | 60.32 | 65.02 | 67.19 | 67.19 |
| Polycarbonate polyol (B2) | | | | 56.32 | | | | |
| Olefin ratio A1/(A1 + B1 + B2) | 0.00 | 0.00 | 0.00 | 0.00 | 0.00 | 0.00 | 0.00 | 0.00 |
| Carbonate ratio | 1.00 | 1.00 | 1.00 | 1.00 | 1.00 | 1.00 | 1.00 | 1.00 |
| (B1 + B2)/(A1 + B1 + B2) | | | | | | | | |
| TMP | 3.5 | 2 | 2 | 2 | 2 | 0.3 | | |
| Bis-MPA | 5.13 | 5.13 | 5.13 | 5.31 | | 5.13 | 5.13 | 5.13 |
| Polyisocyanate compound (C1) | | | | | 30 | | | |
| Polyisocyanate compound (C2) | 38 | 34 | 34 | 34 | | 27 | 26 | 26 |
| Amine extender (EDA) | 2.55 | 2.55 | 2.55 | 2.55 | 2.55 | 2.55 | | 1.68 |
| Amine extender (DETA) | | | | | | | 1.68 | |
| Neutralization salt (TEA) | | | 3.87 | | | | | |
| Neutralization salt (Li) | 1.6 | 1.6 | | 1.6 | 1.6 | 1.6 | 1.6 | 1.6 |
| Crosslink density [mol/kg] | 0.261 | 0.149 | 0.149 | 0.149 | 0.149 | 0.022 | 0.163 | 0 |
| Electrolyte solution resistance | 85 | 210 | 198 | 203 | 229 | 583 | 188 | Dissolved |
| 1 kHz ACR [Ω] | 0.96 | 0.58 | 0.54 | 0.5 | 0.6 | 0.88 | 0.5 | 1.71 |
| 1 C Discharge retention rate [%] | 88 | 93 | 92 | 94 | 92 | 92 | 92 | 88 |
| 2 C Discharge retention rate [%] | 75 | 83 | 82 | 81 | 83 | 80 | 82 | 25 |
| DCR [Ω] | 1.7 | 1.4 | 1.3 | 1.5 | 1.4 | 1.7 | 1.4 | 2.5 |

The comparison between Examples 1 to 5 and Comparative Example 1 showed that in the cases where the polyol used for the polyurethane resin contained a polycarbonate polyol and a polyolefin polyol, the internal resistances were low and output characteristics were good compared with the case where no polycarbonate polyol was contained.

The comparison between Examples 6 to 12 and Comparative Example 2 showed that in the cases where the crosslink density of the polyurethane resin was 0.02 mol/kg or more and 0.28 mol/kg or less, the internal resistances were low and output characteristics were good compared with the case where the crosslink density of the polyurethane resin was less than 0.02 mol/kg.

### <Impossible or Impractical Circumstances>

The aqueous polyurethane resin dispersion for a secondary battery separator of this embodiment includes an aqueous polyurethane resin dispersion containing a polyurethane resin dispersed in water, the polyurethane resin being obtained by reacting a polyol and a polyisocyanate compound. Since this polyurethane resin has a complex structure, it is difficult to represent the structure by a general formula. Furthermore, since the structure is not defined, characteristics of the substance determined according to the structure cannot also be easily defined. Thus, it is impossible to define the aqueous polyurethane resin dispersion of this embodiment directly based on its structure or characteristics.

### INDUSTRIAL APPLICABILITY

The results described above show that the aqueous polyurethane resin dispersion of this embodiment can be suitably used for a secondary battery separator. A secondary battery using the aqueous polyurethane resin dispersion of this embodiment is useful not only as power sources for mobile devices but also as medium-sized or large-sized lithium-ion secondary batteries that are installed on or as electric tools, electric bicycles, electric wheelchairs, robots, electric cars, emergency powers, and large-capacity stationary power sources.

The present invention is not limited to the above-described embodiments and can be realized in various configurations without departing from the gist thereof. For example, the technical features in the embodiments and Examples corresponding to the technical features in each of the aspects described in the section of Summary of Invention can be replaced or combined as appropriate to solve part or the entirety of the above-described problems or to attain part or the entirety of the above-described advantageous effects. In addition, unless the technical features are described as being essential in this specification, the technical features can be omitted as appropriate.

1. An aqueous polyurethane resin dispersion for a secondary battery separator,
the aqueous polyurethane resin dispersion comprising a polyurethane resin dispersed in water, the polyurethane resin being obtained by reacting a polyol, a polyisocyanate compound, and a chain extender,
wherein the polyol contains a polycarbonate polyol, and
the polyurethane resin has a crosslink density of 0.02 mol/kg or more and 0.28 mol/kg or less.

2. The aqueous polyurethane resin dispersion for a secondary battery separator according to claim 1,
wherein the polyol contains a polyhydric polyol.

3. An aqueous polyurethane resin dispersion for a secondary battery separator,
the aqueous polyurethane resin dispersion comprising a polyurethane resin dispersed in water, the polyurethane resin being obtained by reacting a polyol, a polyisocyanate compound, and a chain extender,
wherein the polyol contains a polycarbonate polyol and a polyolefin polyol.

4. The aqueous polyurethane resin dispersion for a secondary battery separator according to claim 3,
wherein, in the polyol, a content of the polycarbonate polyol is 10 parts by mass or more and 95 parts by mass or less relative to 100 parts by mass of a total content of the polycarbonate polyol and the polyolefin polyol.

5. A separator for a secondary battery,
the separator being obtained using the aqueous polyurethane resin dispersion for a secondary battery separator according to claim 1.

6. A secondary battery comprising:
a positive electrode, a negative electrode, a separator, and an electrolyte solution, wherein the separator is the separator for a secondary battery according to claim 5.

7. A separator for a secondary battery,
the separator being obtained using the aqueous polyurethane resin dispersion for a secondary battery separator according to claim 3.

8. A secondary battery comprising:
a positive electrode, a negative electrode, a separator, and an electrolyte solution, wherein the separator is the separator for a secondary battery according to claim 7.
